(19) United States
(12) Patent Application Publication
(10) Pub. No.: US 2004/0125621 A1
(43) Pub. Date: Jul. 1, 2004

(54) Synchronous rectifier of flyback power converter

(76) Inventors: Ta-yung Yang, Milpitas, CA (US); Jenn-yu G. Lin, Taipei (TW); Chern-Lin Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,224

(22) Filed: Dec. 30, 2002

(51) Int. Cl. H02M 3/335

(52) U.S. Cl. 363/21.14

(57) ABSTRACT

A flyback power converter has a transformer, a primary circuit and a secondary circuit. A switching device controlled by a switching signal is disposed in the primary circuit to control the switching of the transformer. The secondary circuit further has an output capacitor connected at the output of the power converter and a synchronous rectifier connected in between the transformer and the output capacitor. A controller is connected to the synchronous rectifier to control on/off status of thereof in response to a secondary current and a synchronous detection signal for both discontinuous and continuous operation mode, wherein the secondary current is generated in the secondary circuit and the synchronous detection signal is produced by detecting the switching signal through the secondary winding of the transformer. In one embodiment, the equivalent series resistance (ESR) of the output capacitor is used as a sensor to detect the secondary current. Therefore, no additional current sensor is required and the efficiency is improved.

### BACKGROUND OF INVENTION

1. Field of Invention

The present invention relates in general to a pulse-width-modulation (PWM) flyback power converter, and more particularly, to a flyback power converter with a synchronous rectifier to improve the efficiency of power conversion.

2. Description of Related Art

Power converters have been frequently used for converting an unregulated power source to a constant voltage source. Among a nearly endless variety of power converters, the flyback power converter has one of the most common topologies. A transformer having a primary winding and a secondary winding is typically the heart of the flyback power converter. In application, the primary winding is connected to an unregulated power source, preferably a DC voltage source, and a switching device is connected to the primary winding to switch on and off the connection between the power source and the primary winding. A rectifying diode is typically connected to the secondary winding for rectifying the energy transferred from the primary winding into a DC voltage.

FIG. 1 shows the topology of a conventional flyback converter. The flyback converter comprises a transformer 10, a switching device 5 connected to the primary winding PW of the transformer 10, a rectifying diode 15 and an output capacitor 30 connected to the secondary winding SW of the transformer 10. The flyback converter operates in a two-step or two-phase cycle. In the first step, the switching device 5 is closed to establish the connection between the power source V_{IN} and the primary winding PW. Meanwhile, as the diode 15 in the secondary winding SW is reversely biased, the secondary winding SW is cut off, and the primary winding PW operates as an inductor and stores energy. In the second step, the switching device 5 is open, such that the primary winding PW is disconnected from the power source V_{IN}. Under such conditions, the energy stored in the transformer is released through the secondary winding SW, and then stored into the output capacitor 30.

In the topology as shown in FIG. 1, when the energy is released through the second winding SW, a forward voltage drop across the rectifying diode 15 inevitably causes conduction loss and renders the rectifying diode 15 as the dominant loss component. To resolve the power loss problem, a low-on-resistance MOSFET transistor has been used to replace the rectifying diode 15 and provides synchronous rectification of the flyback power converter.

FIG. 2 shows a conventional flyback power converter with a MOSFET synchronous rectifier (SR) 20. Similarly to the topology as shown in FIG. 1, the flyback power converter comprises a transformer 10, a switching device 5 controlling conduction status between the primary winding PW of the transformer 10 and an input voltage source V_{IN}, and an output capacitor 30 at the output of the secondary winding SW of the transformer 10. Unlike the topology as shown in FIG. 1, the flyback power converter as shown in FIG. 2 comprises a MOSFET synchronous rectifier 20 to reduce the rectification loss.

A flyback power converter normally has two different modes of operations, discontinuous operation mode and continuous operation mode. In the discontinuous operation mode, all the energy stored in the transformer is completely delivered before the next cycle is started. Therefore, no inducted voltage remains in the transformer to resist the output capacitor discharging back to the transformer. As shown in FIG. 2, when the flyback power converter is operated under the discontinuous operation mode, at the switching instant that the energy of the transformer 10 is completely delivered, a reverse current will be discharged from the output capacitor 30.

As mentioned above, when the primary winding PW is conducted to the input voltage source V_{IN} by closing the switching device 5 in the first operation phase, energy is stored in the transformer 10. The energy ε stored in the transformer 10 can be expressed as:

ε=Lp ×Ip²/2,

where Lp is the inductance of the primary winding PW, and Ip is the current flowing through the primary winding PW. In the discontinuous mode, Ip can be expressed by:

Ip=V_{IN}×T_{ON}/Lp,

where T_{ON} is the duration when the switching device 5 is closed. Therefore, the energy ε is:

ε=V_{IN}²×T_{∩N}²/2Lp.

In the second operation phase, the connection between the primary winding PW of the transformer 10 and the input voltage source V_{IN} is cut off, and the energy stored in the transformer 10 is freewheeled to the output capacitor 30. The discontinuous mode is typically operated under the light load condition, under which the energy stored in the transformer 10 is completely released before starting the next switching cycle. By completely releasing the energy stored in the transformer 10, no inducted voltage remains in the transformer 10 to resist the output capacitor 30 discharging back to the transformer 10. Therefore, at the moment that the switching device 5 turned off, a current is discharged from the output capacitor 30 in a reverse direction once the energy stored in the transformer 10 is completely released.

In contrast, in the continuous operation mode, some energy remains in the transformer 10, that is, before the current released in the secondary winding SW reaches zero, the next cycle begins. When the synchronous rectifier 20 is switched off after the start of the next cycle, as shown in FIG. 3, a reverse charging operation of the output capacitor 30 may occur. More specifically, in the continuous mode, the energy stored in the transformer 10 can be expressed as:

ε=[V_{IN}²×T_{109 N}²/(2×Lp)]+[la×V_{IN}×T_{∩N}/T]

where la is a current that represents energy still existing in the transformer when the next switching cycle is started; and T is the switching period of power converter. Under the continuous mode operation, the transformer 10 keeps freewheeling the energy when the next switching cycle starts. If the synchronous rectifier 20 is not switched off before the start of the next switching cycle, the output capacitor 30 will be charged in a reverse direction.

Many approaches of synchronous rectification have been proposed to reduce rectifying loss, for example, U.S. Pat. No. 6,400,583, “Flyback converter with synchronous rectifying” issued to Chi-Sang Lau at Jun. 4, 2002 and “U.S. Pat. No. 6,442,048, “Flyback converter with synchronous rectifying function” issued to Xiaodong Sun and John Xiaojian Zhao at Aug. 27, 2002. However, in these disclosures, the output capacitor is still sharply charged and discharged via the MOSFET synchronous rectifier at the switching instant for both continuous mode and discontinuous mode-. Therefore, the efficiency is reduced and the noise is increased. Further, in the above approaches, the transformer requires an additional auxiliary winding to generate a drive signal to achieve synchronous rectification; and thus increases the complexity thereof.

### SUMMARY OF INVENTION

The present invention provides a flyback power converter, comprising a transformer having one primary winding and one secondary winding, a primary circuit coupled to the primary winding and a secondary circuit coupled to the secondary winding. The primary circuit further comprises a switching signal controlling the conduction of a switching device between the primary winding and an input voltage source. The secondary circuit coupled to the secondary winding further comprises an output capacitor, a synchronous rectifier, and a controller. The output capacitor is connected in the output terminal of the secondary circuit. The synchronous rectifier is connected in between the secondary winding and the secondary circuit. The controller is connected to the synchronous rectifier to control on/off status of thereof in response to a secondary current and a synchronous detection signal, wherein the secondary current generated in the secondary circuit and the synchronous detection signal are produced by detecting the switching signal through the secondary winding of the transformer.

In one embodiment of the present invention, the switching signal is operative to control the switching device. When the switching signal is high, a primary current flows through the primary winding by conducting the input voltage source to the primary winding. When the switching signal is low, the conduction is cut off, and the primary current is terminated. The synchronous rectifier further comprises a metal-oxide semiconductor field effect transistor (MOSFET). The controller is operative to switch off the synchronous rectifier when the switching device conducts the primary winding to the input voltage source, and switch on the synchronous rectifier when the switching device disconnects the primary winding from the input voltage source.

The power converter may further comprise a detection diode connected between the synchronous rectifier and the controller to generate a detection signal synchronous to the switching signal. Further, the controller is operative to generate a single-pulse signal in response to the detection signal, and the single-pulse signal is wired with the detection signal in an AND logic operation as an output signal to control on/off status of the synchronous rectifier. The controller is operative to generate a delay-time in accordance with the single-pulse signal. The delay-time is inserted in between the end of the single-pulse signal and the start of the next switching cycle, which ensures the turn-off of the synchronous rectifier before the start of next switching cycle.

In addition, controlled by the output signal wiring the detection signal and the single-pulse signal in an AND logic operation, the controller is operative to switch on the synchronous rectifier upon detection of the secondary current, and switches on the synchronous rectifier only when the secondary current is larger than a threshold value. In this manner, the controller further comprises a threshold detector operative to generate the threshold value. When the secondary current is smaller than the threshold value in the discontinuous operation mode, the synchronous rectifier is switched off. Preferably, the threshold value is substantially zero.

In one embodiment of the present invention, the controller further comprises a detection diode, first to third comparators, a single-pulse signal generator, first and second AND gates, and a D-type flip-flop. The first comparator has a first input coupled to the detection diode, a second input coupled to a first reference voltage and an output. The second comparator has a first input coupled to the detection diode, a second input coupled to a second reference voltage and an output. The third comparator has a first input and a second input coupled to a threshold detector and the secondary circuit. The single-pulse generator has a first input coupled to the output of the first comparator, a second input and an output. The first AND gate has two inputs wiring the output of the third comparator and the output of the single-pulse generator and an output. The D-type flip-flop has an input coupled to the output of the second comparator and a reset input coupled to the output of the first AND gate and an output. The second AND gate with inputs is coupled to the output of the single-pulse generator and the output of the D-type flip-flop.

In addition, the controller further comprises a reference resistor coupled to the second input of the single-pulse generator to adjust the pulse width of the single-pulse signal generated by the single-pulse signal generator. A current source is further couple to the detection diode and the first comparator. The controller may further comprise two constant current sources coupled to the threshold detector for generating the threshold value.

In the above controller, the single-pulse generator further comprises an operation amplifier and a plurality of transistors, a capacitor, an AND gate and a plurality of inverters, and a comparator. The operation amplifier and the transistors are coupled to the reference resistor and a reference voltage to produce a charge current. The capacitor is charged by the charge current to produce a charging time for a single-pulse signal. The AND gate and the inverters produces a discharge for the capacitor, and the comparator provides a threshold value for generating the single-pulse signal.

The present invention further provides a flyback power converter comprising a transformer that has a primary winding and a secondary winding, a switching device, an output capacitor, and a synchronous rectifier. The switching device is connected to the primary winding, and the output capacitor and the synchronous rectifier are connected to the second winding. The synchronous rectifier is switched on upon detection of the current under a discontinuous operation mode, the synchronous rectifier is switched on only when the current generated in the secondary winding is larger than a threshold value.

In the above power converter, a controller is coupled to the synchronous rectifier to control on/off status thereof in response to the current. A shunt resistor can be disposed between the output capacitor and the synchronous rectifier for sensing the current. Or alternatively, the equivalent series resistor of the output capacitor can be used for sensing the current. A small capacitor connected in series with a resistor is coupled parallel with the output capacitor, which is then used to remove a DC portion of voltage existing in the output capacitor. The small capacitor and the resistor are further connected to the controller for detecting the AC portion of the voltage that is generated by the current and the equivalent series resistor of the output capacitor.

The present invention further provides a controller suitable for use in a flyback power converter which comprises a transformer with a primary winding controlled by a switching signal, a secondary winding and a synchronous rectifier connected to the secondary winding, the controller being operative to control on/off status of the synchronous rectifier in response to a current induced in the secondary winding.

The above controller further comprises a detection diode connected to the synchronous rectifier to generate a detection signal synchronous to the switching signal. In addition, the controller also comprises a one-shot signal generator to generate a one-shot signal in response to the detection signal. The detection signal and the one-shot signal are wired in an AND gate for generating an output signal to control the on/off status of the synchronous rectifier. Preferably, the controller is operative to switch on the synchronous rectifier upon detection of the current under a continuous operation mode, and to switch on the synchronous rectifier when the current over a predetermined threshold value is detected under a discontinuous operation mode. Therefore, the controller further comprises at least one threshold detector to generate the predetermined threshold value applied in the discontinuous operation mode.

### BRIEF DESCRIPTION OF DRAWINGS

The accompanying drawings are included to provide a further understanding of the present invention, and are incorporated in and constitute a part of this specification. The drawings illustrate embodiments of the present invention and, together with the description, serve to explain the principles of the present invention.

In the drawings,

FIG. 1 shows a conventional flyback power converter having a rectifying diode in the secondary circuit;

FIG. 2 shows a second operation stage of switching instance for a prior art synchronous rectifying that is operated in the discontinuous mode;

FIG. 3 shows a first opertation stage of switching instance for a prior art synchronous rectifying that is operated in the continuous mode;

FIG. 4 shows a first embodiment of a flyback power converter according to the present invention;

FIG. 5 shows the waveforms of various signals generated in each switching cycle of the flyback power converter under a continuous operation mode;

FIG. 6 shows the waveforms of various signals generated in each switching cycle of the flyback power converter under a discontinuous operation mode;

FIG. 7 shows a circuit diagram of the controller of the flyback power converter as shown in FIG. 4;

FIG. 8 shows the circuit diagram of the single-pulse signal generator of the controller as shown in FIG. 4;

FIG. 9 shows a second embodiment of a flyback power converter according to the present invention; and

FIG. 10 shows a third embodiment of a flyback power converter according to the present invention.

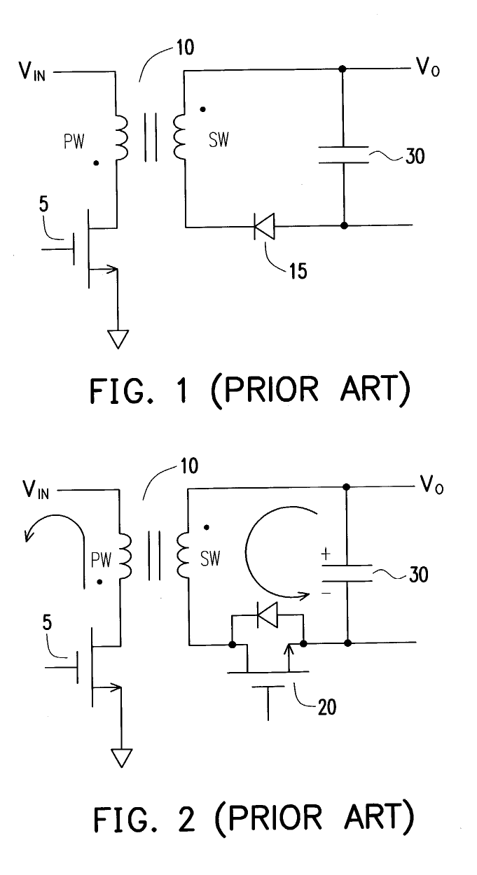

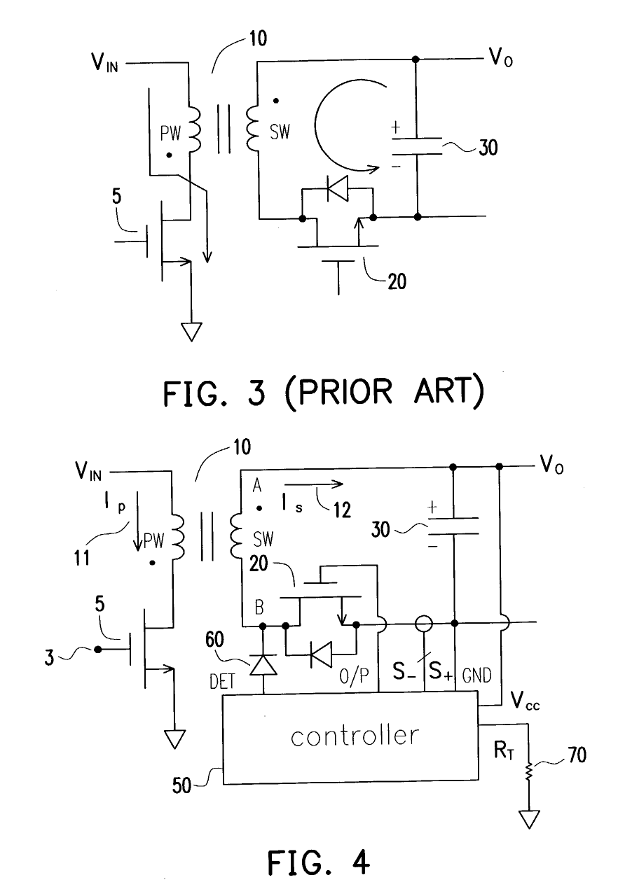

### DETAILED DESCRIPTION

FIG. 4 shows a circuit diagram of a flyback power converter having a synchronous rectifier according to the present invention. In FIG. 4, the flyback power comprises a transformer 10 with a primary winding PW connected to a primary circuit and a secondary winding SW connected to a secondary circuit. In the primary circuit, the PW is connected to an input voltage source V_{IN} via a switching device 5. The secondary circuit comprises a synchronous rectifier 20 connected to a terminal B of the secondary winding SW, an output capacitor 30 connected between a terminal A of the secondary winding SW and an output terminal of the secondary circuit, and a controller 50 coupled to the synchronous rectifier 20. Terminals A and B are shown in FIG. 4.

Preferably, the synchronous rectifier 20 includes a metal-oxide semiconductor field effect transistor (MOSFET) with a gate, a drain and a source. In FIG. 4, a detection diode 60 is connected between the synchronous rectifier 20 and a detection input DET of the controller 50, while the gate of the synchronous rectifier 20 is coupled to an output terminal O/P of the controller 50. The controller 50 further comprises a threshold detector S+/S− for detecting the current 12 flowing through the secondary winding SW. As shown in FIG. 4, the threshold detector S+/S− is connected between the synchronous rectifier 20 and the output capacitor 30. The output capacitor 30 is further connected to a ground terminal (GND) of the controller 50. The output voltage V_{O} of the secondary circuit, that is, the power converter, supplies a source voltage Vcc to the controller 50, and the controller 50 is further connected to a resistor 70 (R_{T}).

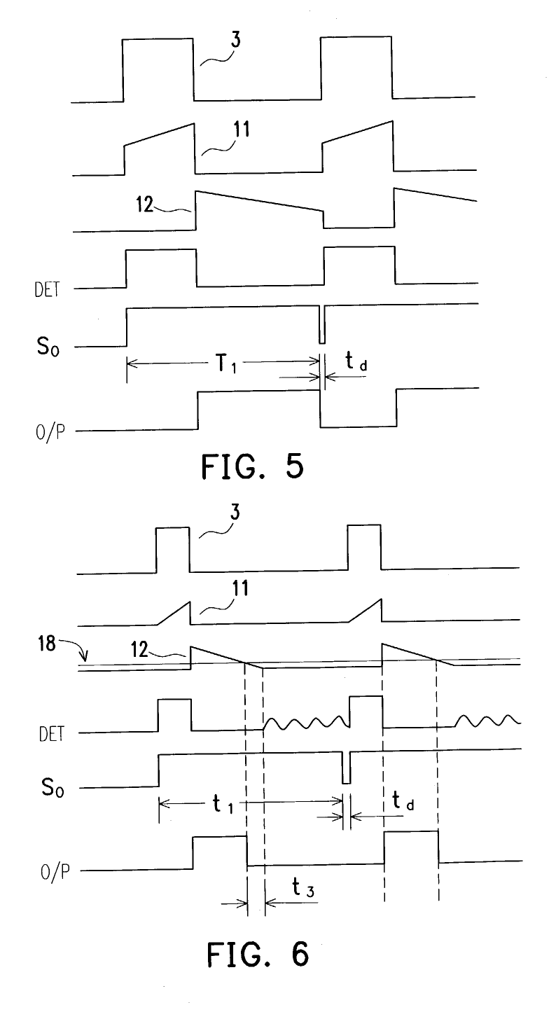

Referring to FIGS. 4 and 5, in a continuous operation mode, by turning on and off the switching device 5 by generating a switching signal 3 in the primary circuit, the current 11 is generated and flows through the primary winding PW to store energy into the transformer 10. The current 11 is in phase with the switching signal 3. Meanwhile, the detection diode 60 in the secondary circuit is reversed biased, and a signal DET is high detected by the detection diode 60 to enable a single-pulse signal So of the controller 50. As shown in FIG. 5, the signal DET is synchronous with the switching signal 3. That is, when the switching signal 3 is raised to high, the signal DET is high. In contrast, when the switching signal 3 drops to zero or lower, the signal DET falls to zero or lower. As the detection signal DET and the one-pulse signal So are wired in an AND logic operation and then output to the gate of the synchronous rectifier 20 from an output terminal O/P of the controller 50, the synchronization between the switching signal 3 and the synchronous rectifier 20 is thus obtained. As shown in FIG. 4, the controller 50 is further connected to a resistor 70 for programming the pulse width of the single pulse signal So in response to the switching frequency of the power converter. For example, in this embodiment, the pulse width of the single-pulse signal is approximately the same as the switching period of the power converter.

Once the switching device 5 disconnects the conduction between the input voltage source V_{IN} and the primary winding PW, the current 11 is terminated, and the current 12 is induced to flow through the secondary winding SW to the secondary circuit. As a result, the energy stored in the transformer 10 is delivered to the output terminal as the output voltage Vo and the output capacitor 30, and the parasitic diode of the synchronous rectifier 20 is forward biased and conducted. Since the parasitic diode is conducted, the signal DET is detected low by the detection diode 60 and input to the controller 50. The low-level signal DET, again, is wired with the single-pulse signal So in an AND logic operation to generate an output signal O/P to switch on the synchronous rectifier 20.

In a discontinuous operation mode as shown in FIG. 6, a programmable threshold detector S−/S+ is activated to sense the current 12 generated in the secondary winding SW and control the synchronous rectifier 20. FIG. 6 shows the waveforms of various signals generated in the discontinuous operation mode. Again, when the switching device 5 is conducted and the switching signal 3 is high, the current 11 is generated in the primary circuit and flows through the primary winding PW. Meanwhile, the detection signal DET is detected high to enable the single-pulse signal So. When the switching device 5 is open, the switching signal 3 drops to low, and the current 11 is cut off, the detection signal DET drops to low as well. Meanwhile, the current 12 is generated in the secondary circuit, and the energy stored in the transformer 10 is delivered to the output terminal as the output voltage Vo and to the output capacitor 30. Before starting the next switching cycle, that is, before switching the switching signal 3 to high again, the current 12 is reduced to zero. The programmable threshold detector S−/S+ is programmed to set up a threshold value 18 that allows the synchronous rectifier 20 to remain on. Therefore, the synchronous rectifier 20 is turned off as long as the current 12 is below the threshold value 18. As shown in FIG. 6, switching off the synchronous rectifier 20 before the current 12 reaches zero, the output capacitor 30 is prevented from discharging in a reverse direction.

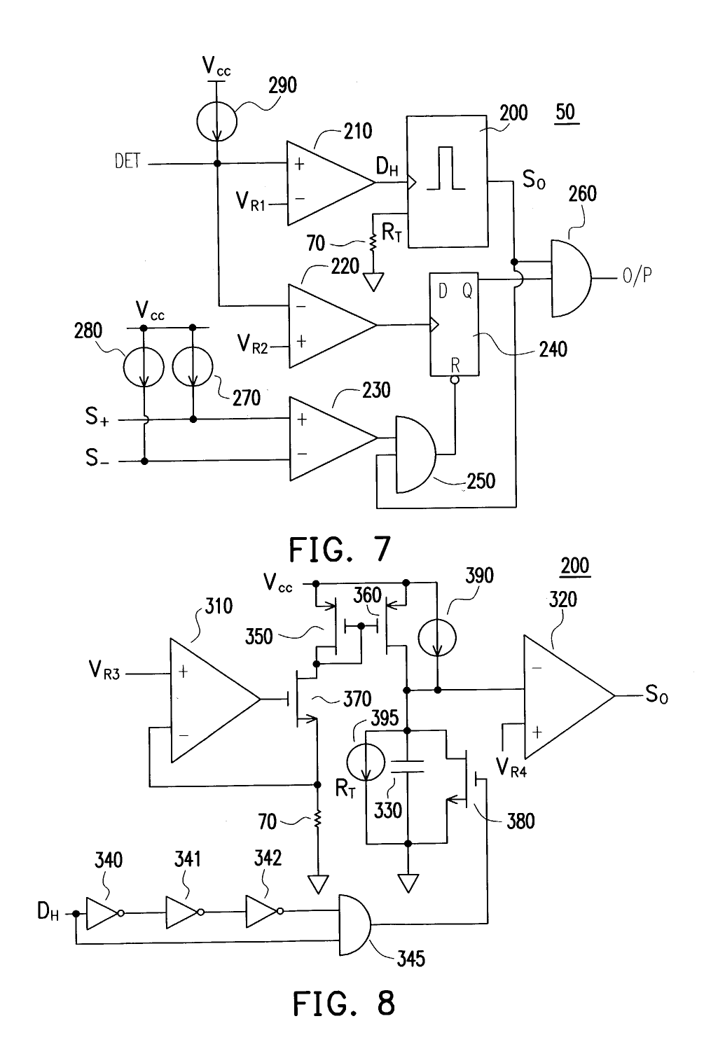

FIG. 7 shows a circuit diagram of the controller 50 in one embodiment of the present invention. As shown in FIG. 7, the controller 50 comprises current sources 270, 280 and 290, comparators 210, 220 and 230, a single-pulse generator 200, a D-type flip-flop 240, and AND gates 250 and 260. The current source 290 is connected to a voltage source Vcc for pulling up the detection signal DET. Referring to FIG. 4, the voltage source Vcc is sourced from the output voltage Vo of the secondary circuit. As FIG. 7 shows, the comparator 210 has a positive input coupled to the detection signal DET, a negative input coupled to a reference voltage V_{R1}, and an output coupled to the single-pulse generator 200. When the detection signal DET is higher than the reference voltage V_{R1}, a signal D_{H} is output to initiate the single-pulse generator 200 for generating the single-pulse signal So.

Further referring to FIG. 7, the comparator 220 has a negative input coupled to the detection signal DET, a positive input coupled to a reference voltage V_{R2}, and an output coupled to the D-type flip-flop 240. When the detection signal DET is lower than the reference voltage V_{R2}, the output of the comparator 220 clocks the output of the D-type flip-flop 240 to a level high. The constant current sources 270 and 280 are connected to the threshold detector S+ and S− respectively for generating the threshold value such as the threshold value 18 shown in FIG. 6. Connecting the resistors from S+ or S− to the ground of controller 50 technically produces the threshold value. The comparator 230 senses the current 12 shown in FIG. 4 and compares the current 12 with the threshold value, so as to control the on/off status of the synchronous rectifier 20. That is, only when the current 12 is over the threshold value, a signal output from the comparator 230 is wired with the single-pulse signal So in the AND gate 260 to generate an output signal O/P operative to switch on the synchronous rectifier 20. The AND gate 250 performing an AND operation on the single pulse. signal So and the output of the comaprator 230 is used to reset the D-type flip-flop 240.

In FIG. 8, one embodiment of the single-pulse generator 200 is illustrated. As shown in FIG. 8, the single-pulse generator 200 comprises an operation amplifier 310, transistors 370, 350, 360, 380, resistor 70 (R_{T}), programmable current sources 390, 395, capacitor 330, an AND gate 345, and inverters 340, 341, 342. The operation amplifier 310 has a positive input coupled to a reference voltage V_{R3}, a negative input coupled to the resistor 70, and an output coupled to a transistor 370. The transistor 370 is further connected to the resistor 70 and the mirrored transistors 350 and 360, such that a charging current I₃₆₀ can be obtained by:

I₃₆₀=(VR₃/R₇₀)/(N₃₆₀/N₃₅₀),

where N₃₆₀/N₃₅₀ is the geometric ratio of the mirrored transistors 350 and 360.

The reference voltage V_{R4} coupled to the comparator 320 provides a threshold voltage for generating the single-pulse signal So. The capacitor 330 and the current I₃₆₀ are connected to two programmable current sources 390 and 395, by which a single-pulse time Ti for the single-pulse signal So is determined as:

T1=(C₃₃₀×VR₄)/(I₃₆₀+I₃₉₀−I₃₉₅)Where C₃₃₀ is the capacitance of the capacitor 330. Therefore, a delay time Td for starting the next switching cycle can be expressed as:

Td=T−T1, where T is the period of the switching signal 3.

When the transformer 10 operates in continuous operation mode, the delay time t_{d} ensures the turning-off of the synchronous rectifier 20 before the start of the next switching cycle therefore, preventing a backward charging to the output capacitor 30 and protecting the synchronous rectifier 20 from over-stress switching. Accordantly, a proper t_{d} value is significant for the synchronous rectifying. A wider delay is need for the switching, however on the contrary a shorter delay will achieve a higher efficiency.

The currents I₃₉₅ and I₃₉₀ of the programmable current sources 395 and 390 are developed as the function of delay time t_{d} as shown in FIG. 5, 6. More specifically, the current I₃₉₀ is decreased and the current I₃₉₅ is increased when the delay time t_{d} is shortened. In contrast, when the delay time t_{d} is increased, the current I₃₉₀ is increased and the current I₃₉₅ is decreased. In the case that the switching frequency of the switching device 5 is varied due to temperature variation, degradation of components or other factors, foregoing control mechanism is used to optimize the delay time t_{d}.

Further referring to FIG. 8, the input signal D_{H} is delayed by the inverters 340, 341 and 342 before entering one input of the AND gate 345, while the input signal D_{H} is input to the other input of the AND gate 345. Thereby, the transistor 380 is driven by a discharge pulse to discharge the capacitor 330, so as to initiate the next single-pulse signal.

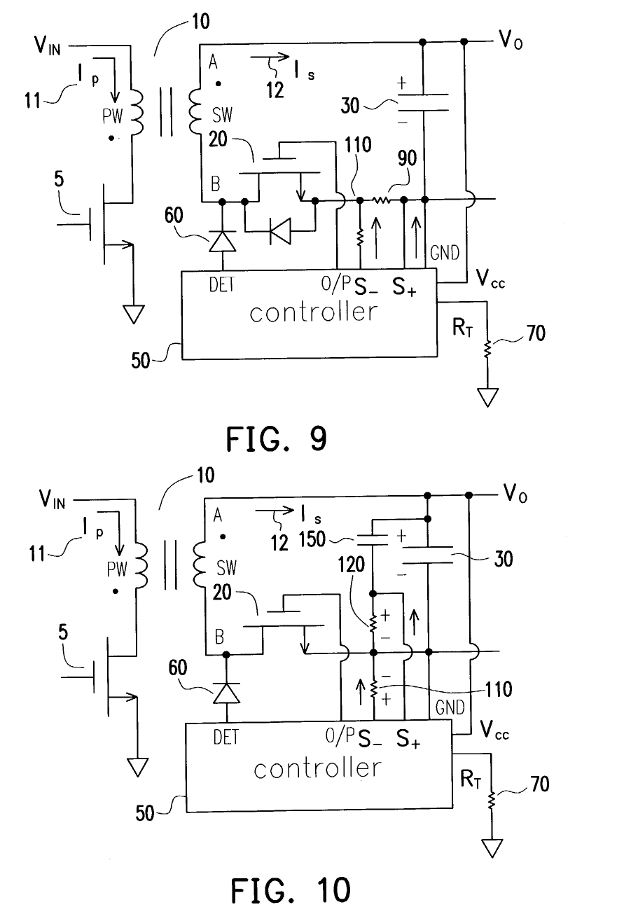

FIG. 9 shows another embodiment of a flyback power converter provided by the present invention. In FIG. 9, a shunt resistor 90 is inserted between the synchronous rectifier 20 and the capacitor 30 to sense the current 12. A resistor 110 is connected between the synchronous rectifier 20 and the shunt resistor 90 to the threshold detector S− of the controller 50. Referring to FIG. 7, the resistor 110 shown in FIG. 9 is further connected to the constant current source 280 to produce the threshold value such as the threshold value 18 as shown in FIG. 6 in the discontinuous operation mode.

FIG. 10 shows another embodiment of a flyback power converter provided by the present invention. As shown in FIG. 10, similar to the above, the power converter comprises a transformer 10 with a primary winding PW and a secondary winding SW coupled to a primary circuit and a secondary circuit, respectively. In the primary circuit, a switching device 5 is installed to control the connection between the primary winding PW and an input voltage source V_{IN}. In the secondary circuit, a synchronous rectifier 20, preferably a MOSFET, is connected to the terminal B of the secondary winding SW, and an output capacitor 30 is coupled between the terminal A of the secondary winding SW and an output terminal thereof.

In the power converter as shown in FIG. 10, an equivalent series resistance (ESR) of the output capacitor 30 is used as a sensor to detect the current 12 flowing along the secondary winding SW. Therefore, no additional current sensor is required in this embodiment; and consequently, the efficiency is improved, and the cost is reduced. As shown in FIG. 10, a capacitor 150 and a resistor 120 are connected in series and parallel coupled to the output capacitor 30 for removing the DC portion of the voltage in the output capacitor 30. As a result, only the AC portion of the voltage in the output capacitor 30 is detected thereby. The voltage across the resistor 120 connected to the threshold detector S+ includes a forward bias generated by the constant current source 270 as shown in FIG. 7 and the AC portion of the voltage in the capacitor 30:

V₁₂₀=V_{DC}+ΔV,

where

V_{DC}=I₂₇₀×R_{120,}

and

ΔV=ΔI_{S}×R_{ESR}

A resistor 110 is connected from threshold detector S− to the ground of the controller 50 to produce the threshold value. The synchronous rectifier 20 is conducted only when the voltage across the resistor 120, that is, V₁₂₀, is higher than the voltage of I₂₈₀×R₁₁₀, wherein the R110 is the resistance of the resistor 110, and the I₂₈₀ is the current of the constant current source 280 as shown in FIG. 7.

It will be apparent to those skilled in the art that various modifications and variations can be made to the structure of the present invention without departing from the scope or spirit of the present invention. In view of the foregoing, it is intended that the present invention cover modifications and variations of this invention provided that they fall within the scope of the following claims and their equivalents.

1. A flyback power converter, comprising:
a transformer, having one primary winding and one secondary winding;
a primary circuit coupled to the primary winding, the primary circuit further comprising a switching signal operative to control a switching device for controlling on/off status of the conduction between the input voltage source and the primary winding; and
a secondary circuit coupled to the secondary winding, the secondary circuit further comprising:
an output capacitor, connected between a first terminal of the secondary winding and an output terminal of the secondary circuit;
a synchronous rectifier, connected to a second terminal of the secondary winding; and
a controller, connected to the synchronous rectifier, to control on/off status of the synchronous rectifier in response to a secondary current and a synchronous detection signal, wherein the secondary current is generated in the secondary circuit and the synchronous detection signal is produced by detecting the switching signal through the secondary winding of the transformer.

2. The power converter as recited in claim 1, further comprising a detection diode connected between the synchronous rectifier and the controller, the detection diode being operative to generate a detection signal in response to the detection of the switching signal through the secondary winding of the transformer; wherein the detection signal is synchronous to a switching signal generated by the switching device.

3. The power converter as recited in claim 2, wherein the controller is operative to generate a single-pulse signal in response to the detection signal, and the single-pulse signal is wired with the detection signal in an AND logic operation as an output signal to control on/off status of the synchronous rectifier.

4. The power converter as recited in claim 2, wherein the controller is operative to generate a delay-time in accordance with the single-pulse signal; wherein the delay-time is inserted in between the end of the single-pulse signal and the start of the next switching cycle, which ensures the turned-off of the synchronous rectifier before the start of next switching cycle.

5. The power converter as recited in claim 1, wherein the controller is operative to switch on the synchronous rectifier upon detection of the secondary current under a discontinuous operation mode, and switching on the synchronous rectifier only when the secondary current is larger than a threshold value.

6. The power converter as recited in claim 5, wherein the controller further comprises a threshold detector operative to generate the threshold value.

7. The power converter as recited in claim 1, wherein the controller further comprises:
a detection diode, coupled between the synchronous rectifier;
a first comparator, with a first input coupled to the detection diode, a second input coupled to a first reference voltage and an output;
a second comparator, with a first input coupled to the detection diode, a second input coupled to a second reference voltage and an output;
a third comparator, with a first input and a second input coupled to a threshold detector;
a single-pulse generator with a first input coupled to the output of the first comparator, a second input and an output;
a first AND gate, with two inputs wiring the output of the third comparator and the output of the single-pulse generator and an output;
a D-type flip-flop with an input coupled to the output of the second comparator and a reset input coupled to the output of the first AND gate and an output; and
a second AND gate with inputs coupled to the output of the single-pulse generator and the output of the D-type flip-flop.

8. The power converter as recited in claim 7, wherein the controller further comprises a reference resistor coupled to the second input of the single-pulse generator.

9. The power converter as recited in claim 7, wherein the controller further comprises two constant current sources coupled to the threshold detector for generating the threshold value.

10. The power converter as recited in claim 7, wherein the single-pulse generator further comprises:
an operation amplifier and a plurality of transistors associated with the reference resistor to produce a constant charge current;
a programmable charge current and a programmable discharge current;
a capacitor, charged by the constant charge current, the programmable charge current and discharged by the programmable discharge current to produce a charging time for generating the single-pulse signal, in which the pulse width of the single-pulse signal is reduced in response to the increase of programmable charge current, and the pulse width of the single-pulse signal is increased in response to the increase of the programmable discharge current;
wherein an optimized pulse width of the single-pulse signal is obtained by regulating the programmable charge current and the programmable discharge current,
an AND gate and a plurality of inverters to produce a discharge for the capacitor; and
a comparator to provide a threshold value for generating the single-pulse signal.

11. The power converter as recited in claim 10, wherein the programmable charge current and the programmable discharge current are developed as the function of the delay-time, in which the programmable charge current is decreased and the programmable discharge current is increased when the delay-time is shortened, wherein in contrast, the programmable current is increased and the programmable discharge current is decreased when the delay-time is increased.

12. A flyback power converter, comprising:
a transformer, having a primary winding and a secondary winding;
a switching device, connected to the primary winding;
an output capacitor, connected to a first terminal of the secondary winding;
a synchronous rectifier, connected to a second terminal of the secondary winding, wherein:
the synchronous rectifier being switched on upon detection of a current generated in the secondary winding under a discontinuous operation mode; and
the synchronous rectifier being switched on when the current generated in the secondary winding is larger than a threshold value.

13. The power converter as recited in claim 12, further comprising a shunt resistor connected between the output capacitor and the synchronous rectifier to sense the current.

14. The power converter as recited in claim 12, further using an equivalent series resistor of the output capacitor to sense the current.

15. The power converter as recited in claim 14 further comprises:
a blocking capacitor connected to the output capacitor; and
a first resistor connected to the blocking capacitor in series.

16. The power converter as recited in claim 15, further comprising a second resistor connected between the threshold detector and the ground of the controller to produce the threshold value.

17. A controller, suitable for use in a flyback power converter which comprises a transformer with a primary winding controlled by a switching signal, a secondary winding and a synchronous rectifier connected to the secondary winding, the controller being operative to control on/off status of the synchronous rectifier in response to a secondary current and a synchronous detection signal, wherein the secondary current generated in the secondary winding and the synchronous detection signal produced by detecting the switching signal through the secondary winding of the transformer.

18. The controller as recited in claim 17, further comprising a detection diode connected to the synchronous rectifier to generate a detection signal synchronous to the switching signal.

19. The controller as recited in claim 18, further comprising a one-shot signal generator to generate a one-shot signal in response to the detection signal.

20. The controller as recited in claim 19, further comprising an output wiring the detection signal and the one-shot signal in an AND logic operation for controlling the on/off status of the synchronous rectifier.

21. The controller as recited in claim 17, wherein the controller is operative to switch on the synchronous rectifier upon detection of the current under a discontinuous operation mode, and to switch off the synchronous rectifier when the current over a predetermined threshold value is detected.

22. The controller as recited in claim 21, wherein the controller further comprising at least one threshold detector to generate the predetermined threshold value.
